(19) United States
(12) Patent Application Publication
(10) Pub. No.: US 2018/0054031 A1
(43) Pub. Date: Feb. 22, 2018

(54) RELATING TO, HEATING

(71) Applicant: ARGUS HEATING LIMITED, Christchurch (NZ)

(72) Inventor: Murray John Philpott, Christchurch (NZ)

(73) Assignee: ARGUS HEATING LIMITED, Christchurch (NZ)

(21) Appl. No.: 15/510,987

(22) PCT Filed: May 9, 2016
(86) PCT No.: PCT/NZ2016/050073

§ 371 Date: Mar. 13, 2017

(30) Foreign Application Priority Data
May 8, 2015 (NZ) 707891

(51) Int. Cl. H01R 29/00; H05B 3/02; B65D 88/74

(52) U.S. Cl. CPC H01R 29/00; B65D 88/74; H05B 3/02

(57) ABSTRACT

Disclosed is a multi-voltage electrical apparatus comprising or including, an electrical load that can connect via an electrical connection separately to both of either, a first electrical source at a first voltage, and a second electrical source at a second voltage. The electrical load is connected in series via the electrical connection to the first electrical source, or in parallel via the electrical connection to the second electrical source. The electrical load when connected in series or parallel having substantially the same power output.

### PRIORITY CLAIM

This application claims the benefit of New Zealand Patent Cooperation Treaty application number PCT/NZ2016/050073, filed May 9, 2016, which claims benefit to New Zealand application number NZ 707891, filed May 8, 2015, the contents of which are incorporated by reference.

### FIELD OF THE INVENTION

The present invention relates to electrical connections for slip heater pads.

In particular, though not solely, the present invention is directed to dual voltage connectors which are passive and allow for connection to one or another voltage to power a universal slip heater pad for example for heating of an Intermediate Bulk Container (IBC).

### BACKGROUND OF THE INVENTION

A problem arises when product moves from one country to another that requires an electrical connection. This problem is further compounded when it moves from one country to another and those countries have differing electrical levels, for example 230 VAC for Australia or New Zealand, and then 115 VAC for the United States.

There have been various solutions up until now.

One solution to connecting the same item into both voltages has required an active power supply to drop or raise the voltage to the operating voltage of the connected equipment. This has the problem of the added cost and potential fragility of the power supply. This problem is exacerbated when the attached equipment is considered a throwaway product, and therefore there is no re-use of the equipment or power supply. This leads to cost and waste.

The solution of having these power sources at each site is undesirable from a point of view of cost and maintenance, and the location may not have the ability or capacity to support a multitude of power supplies, sources and connections.

Another solution is to have the equipment requiring connection to have dual circuits, one rated for one voltage and another rate for another, and so on. This duplication can be wasteful in cost and materials because it may only be one voltage connection ultimately that is needed, for example at destination. Therefore the duplicated circuit for the other voltage is not used.

Another solution can be the use of an interchangeable circuit board to allow connection 240 VAC and 110 VAC to the connected equipment. However the cost of such circuit board systems can be relatively high and reliability may become an issue. Also this system requires the time and effort of the user to switch the circuit board over and is reliant on the user having checked the correct circuit board is in place or changing the board over for the correct voltage. This is a draw back and may allow connection of the incorrect voltage.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is therefore an object of the present invention to provide an improved multi-voltage electrical connection, or to overcome the above shortcomings or address the above desiderata, or to at least provide the public with a useful choice.

### SUMMARY OF THE INVENTION

In a first aspect the present invention may be said to broadly consist in a multi-voltage electrical apparatus comprising or including an electrical load that can connect via an electrical connection separately to both of either a first electrical source at a first voltage, and a second electrical source at a second voltage, wherein said electrical load is connected in series via said electrical connection to said first electrical source, or in parallel via said electrical connection to said second electrical source, said electrical load when connected in series or parallel having substantially the same power output.

Preferably said electrical load is a resistive heater.

Preferably said power output of said electrical load is substantially thermal.

Preferably said load is a resistive heater for any one or more of,

an intermediate bulk container,

bulk containers,

drums,

barrels

storage containers,

tanks, and

hoppers.

Preferably said electrical connection has a termination for connection with said electrical load.

Preferably said electrical connection is supplied at least with said termination in a first configuration for series connection of said electrical load to said first electrical source.

Preferably said electrical connection is supplied with said termination in a second configuration for parallel connection of said electrical load to said second electrical source.

Preferably said electrical load has a connection point that can connect to said termination in both said first configuration and said second configuration.

Preferably said series or parallel connection of said electrical load is achieved through series or parallel connection of said electrical load to said first electrical source and said second electrical source respectively via connection of said termination and said connection point.

Preferably said termination consists of a socket.

Preferably said connection point is a plug.

Preferably said termination is at an end of a flexible electrical lead, distal from said power source.

Preferably said connection point is at a periphery of said electrical load.

Preferably said electrical connection has electrical contacts arranged therein to connect said load in parallel or series dependent on whether said first termination or said second termination is connected thereto.

Preferably said first voltage is higher than said second voltage.

Preferably said first voltage is 240 volts alternating current.

Preferably said second voltage is 110 volts alternating current.

Preferably said connection point is mounted on said electrical load, said container or part thereof, or remote from the electrical load at the end of an electrical lead.

In another aspect the present invention may be said to broadly consist in a heating element adapted to heat an intermediate bulk container, comprising or including an electrical load that can connect via an electrical connection separately to both of either, a first electrical source at a first voltage, and a second electrical source at a second voltage, wherein said first electrical source via said electrical connection is applied to said load in series, and said second electrical source via said electrical connection is applied to said to load in parallel, said electrical load when connected in series or parallel said having substantially the same power output.

In another aspect the present invention may be said to broadly consist in a multi-voltage electrical apparatus as described herein with reference to any one or more of the accompanying drawings.

In another aspect the present invention may be said to broadly consist in a heating element as described herein with reference to any one or more of the accompanying drawings.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present, but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements and features, and where specific integers are mentioned herein which have known equivalents in the art to which this invention relates, such known equivalents are deemed to be incorporated herein as if individually set forth.

Other aspects of the invention may become apparent from the following description which is given by way of example only and with reference to the accompanying drawings.

### BRIEF DESCRIPTION OF THE DRAWINGS

Preferred and alternative examples of the present invention are described in detail below with reference to the following drawings:

FIG. 1 shows at (A) and (B) the circuit diagrams of the electrical load connected to an alternating current electrical (first) source in series, and (C) the same electrical load connected to an alternative current electrical (second) source in parallel, and (D) the circuit diagram for the parallel connection,

FIG. 2 shows in plan view the electrical load as a slip pad heater, for example as used to heat an intermediate bulk container,

FIG. 3 shows the slip pad heater located underneath an intermediate bulk container and above a pallet,

FIG. 4 shows a socket as an example of a termination for the electrical sources, in (A) end elevation, (B) side elevation, and (C) top elevation,

FIG. 5 shows a plug for said electrical load complimentary to the socket of FIG. 4 in (A) end elevation, (B) side elevation, and (C) top elevation,

FIG. 6 shows a diagram for connection between the termination from the electrical source and the connection on the electrical load for series connection, and

FIG. 7 shows a diagram for connection between the termination from the electrical source and the connection on the electrical load for parallel connection.

### DETAILED DESCRIPTION OF THE PREFERRED EMBODIMENT

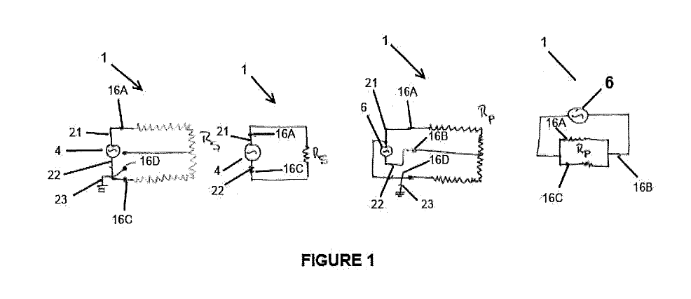

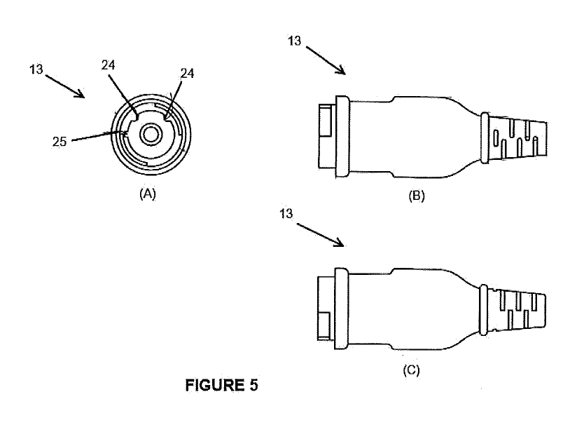

Preferred embodiments will now be described with reference to FIGS. 1 through 7.

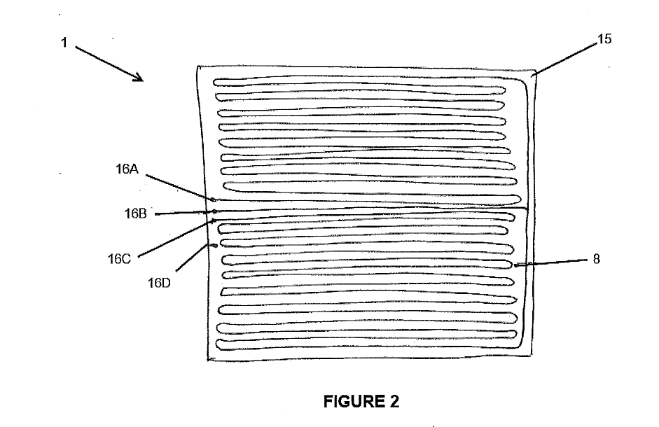

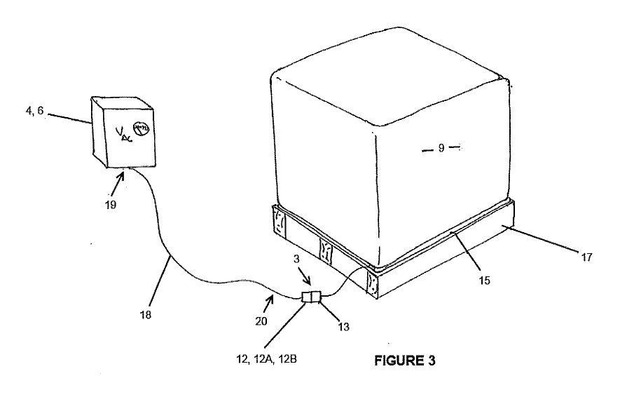

A multi-voltage electrical apparatus 1 is shown in FIG. 1 in wired in series (A and B) and parallel (C and D). The electrical load in one preferred form is a planar winding of resistance wire or heater cable with a given resistance per length (Ohms/m). This planar array, as resistance wire, is shown in FIG. 2 where the planar array is a slip pad heater 15. A slip pad heater 15 as earlier described is used to heat the content of an intermediate bulk container 9, as shown in FIG. 3. As shown in FIG. 3 the slip pad heater 15 is located or incorporated in the components between the bulk container 9 that contains the product to be heated and the pallet 17 the container 9 rests on. As the container content will often weigh in excess of a 1000 kg and the container 9 is fragile the slip pad heater 15 is located underneath the container 9 and above the pallet 17 (or equivalent) in most cases prior to filling the container 9 with its content. Location under the bulk of the product to be heated also enables sufficient heat transfer to the contents of the container due to the increased contact pressure between the container 9 and the heater 15 due to the weight of the product in the container 9.

The slip pad heater 15 shown in FIG. 2 is of known construction and the resistance wire is often laminated between two sheets of film, for example aluminium foil or similar as heat conducting material directly against the container, and heat reflecting material on the outside of the slip pad heater to reflect heat back towards the container 9. In other embodiments the underside may be of paper based material as this is cost effective. The heater 15 is made from a length of resistance wire or heater cable, for example as laid out as shown. The ends of the length terminate in electrical contacts 16A and 16C, and also a mid-point (resistance wise) connection 16B. An earth connection 16D is also shown to allow earthing of the heater 15.

The parallel and series electrical connection of the electrical load is shown schematically in FIG. 1A,B for series and FIG. 1 C, D for parallel. In the preferred form there are three electrical contacts 16A, 16B and 16C, and optionally a fourth electrical contact 16D as an earth on the electrical load, and electrical source live 21, electrical source neutral 22, and electrical source earth 23.

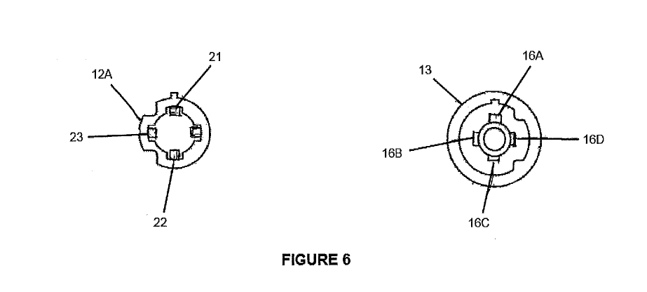

In the series form, shown in FIGS. 1A,B and FIG. 6, the first electrical source 4 is connected in series across electrical load contacts 16A and 16C as shown to form the series circuit with known electrical resistance Rs. In the preferred embodiment electrical source live 21 is connected to electrical contact 16A, electrical load neutral 22 connected to electrical load contact 16C (or vice versa) and electrical source earth 23 connected to electrical load earth 16D.

In the preferred form the first electrical source 4 is 240 Volts alternating (VAC) current, also referred to as 230 VAC, and sometimes as 220 VAC. Other electrical connections may be present for other purposes but are not shown here and are not part of the present invention.

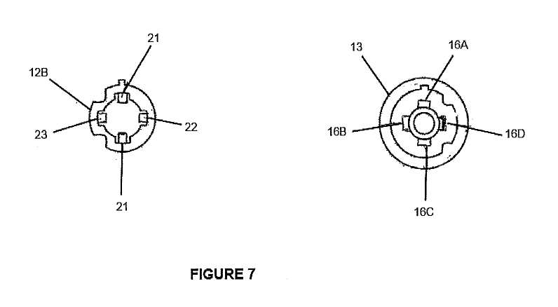

In the parallel form, shown in FIGS. 1C,D and FIG. 7, the second electrical source 6 is connected in parallel across electrical load contacts 16A/16C and 16B as shown to form the parallel circuit with known electrical resistance Rp. In the preferred embodiment electrical source live 21 is connected to electrical contact 16A and 16C, electrical load neutral 22 connected to electrical load contact 16B (or vice versa) and electrical source earth 23 connected to electrical load earth 16D.

In the preferred form the second electrical source 6 is 115 Volts alternating (VAC) current, also referred to as 110 VAC, and sometimes as 120 VAC. Other electrical connections may be present for other purposes but are not shown here and are not part of the present invention.

In use the slip pad heater 15 is located external to the container, and in the preferred embodiment, it is under the intermediate bulk container 9, as shown in FIG. 3. However, in other forms the heater 15 can be located on top, or about the side, or sides of the contents, or a combination thereof, that requires heating by the resistive heater 8.

When the content of the container 9 needs to be heated the heater 15 is connected to the available electrical source 4 or 6—the voltage of which will depend on typically the geographic location the container 9 is in. For example if the container 9 is in the United States the electrical source would typically be 110 VAC (or 115 VAC), and if in New Zealand the voltage would be 230 VAC (or 240 VAC). The present invention contemplates the electrical source is, in the preferred embodiment, single phase.

The connection to the electrical source 4 or 6 in the preferred form is by an electrical cord 18. At the electrical source 4,6 end 19 of the cord 18 there is the typical connection required for that particular source, e.g. three pin plug for New Zealand. At the heater connecting end 20 there is the connection 3 with the resistive heater 8 of the slip pad heater 15. In the preferred embodiment this electrical connection 3 is achieved via a termination that is a socket 12 from the electrical source and a plug 13 as a connection point from the resistive heater 8. However, other forms may be acceptable also. The electrical connection 3 may extend from the slip pad heater 15 with a cord as shown, or may be located on the slip pad heater 15 itself, or maybe mounted on the container 9.

The socket 12 (in the preferred embodiment) of the electrical connection 3 has two configurations, a first 12A (for first termination) and second 12B (for second termination), as shown in FIGS. 6 and 7. The first 12A connects via the plug 13 (as the connection from the electrical load) the electrical load 2 (for example as shown the resistive heater 8) in series to the first electrical source 4, and the second 12B connects via the plug 13 the electrical load (for example as shown the resistive heater 8) in parallel to the second electrical source 6. All the contacts 16A, 16B, and 16C are located in the plug 13, and it is the specific sockets 12A and 12B and the arrangement of their connections inside that connects them in series or parallel with the electrical load of the slip pad as necessary.

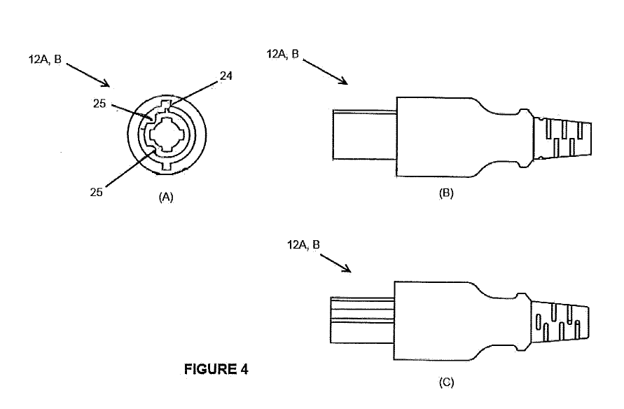

As can be seen in FIG. 4A the plug 12 has so that it can only fit into the plug 13 in one way, thus ensuring correct alignment of the contacts each time. In the preferred form shown there are complimentary keys 24 and keyways 25 in the socket 12 and plug 13 to ensure they connect in the right orientation each time. Optionally there may also be locking portions to hold the two together in addition to any friction between the two, for example, but not limited to clips, or a bayonet style one or two part twist connection (not shown).

Therefore the electrical cord 18 and specific socket 12 connected is specific to a voltage. For example the first socket 12A and its cord 18 for series connection is supplied for example to 230 Vac countries and the second socket 12B and its cord 18 for parallel connection is supplied to 115 Vac countries.

While a plug 13 and socket 12 connection is described here, it could be a socket and plug connection, or any other form of equivalent electrical connection.

When the first electrical source 4 is connected as described above, and is preferably at the higher voltage, the electrical connection 3 connects the resistive heater 8 in series as shown in FIGS. 1A, and B. This is achieved by the arrangement of electrical contacts 21, 22 and 23 within the socket 12A, and their connection to those in the plug 13, as described above. One possible configuration is shown in FIG. 6 where the first socket 12 A is shown and has contacts to the first electrical source of electrical source live 21, electrical source neutral 22 and electrical source earth 23—the fourth contact shown has no electrical function assigned. Likewise in the plug 13, there is the contact 16A to one arm of the electrical load 2, which connects in this configuration to electrical source live 21 in the socket 12A. Likewise there is electrical contact 16C (to the other arm) to electrical source neutral 22, and electrical contact 16D (earth) to electrical source earth 23.

In the alternative when the second electrical source 6 is connected as described above, and is preferably the lower voltage, the electrical connection 3 connects the resistive heater 8 in parallel as shown in FIGS. 1C and D. This is achieved by the arrangement of electrical contacts 21, 22, and 23 within the socket 12B, and their connection to those in the plug 13, as described above. One possible configuration is shown in FIG. 7 where the second socket 12B is shown and has two live contacts to the first electrical source of electrical source live 21, electrical source neutral 22 and electrical source earth 23. Likewise in the plug 13, there is the contact 16A and 16C to one arm of the electrical load 2, which connects in this configuration to electrical source live 21 in the socket 12A. Likewise there is electrical contact 16B (to the other arm) to electrical source neutral 22, and electrical contact 16D (earth) to electrical source earth 23.

The advantage of the present invention is that irrespective of the location of the container 9 and the voltage in that country, the slip pad heater with a standardised plug can be connected by use of the correct plug to the electrical source present. This has advantages in that the slip pad heater, and its electrical connection can be standardised, yet still work with dual voltages.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A multi-voltage electrical apparatus comprising:
an electrical load that can connect via an electrical connection separately to both of either:
a first electrical source at a first voltage, and
a second electrical source at a second voltage,
wherein said electrical load is connected in series via said electrical connection to said first electrical source, or in parallel via said electrical connection to said second electrical source,
wherein said electrical connection has a termination for connecting with said electric load in series or parallel,
said electrical load when connected in series or parallel having substantially the same power output.

2. An apparatus as claimed in claim 1 wherein said electrical load is a resistive heater.

3. An apparatus as claimed in claim 1 or claim 2 wherein said power output of said electrical load is substantially thermal.

4. An apparatus as claimed in claim 1 wherein said electrical load is a resistive heater for any one or more of,
an intermediate bulk container,
bulk containers,
drums,
barrels
storage containers,
tanks, and
hoppers.

5. (canceled)

6. An apparatus as claimed in claim 1 wherein said electrical connection is supplied at least with said termination in a first configuration for series connection of said electrical load to said first electrical source.

7. An apparatus as claimed in claim 1 wherein said electrical connection is supplied with said termination in a second configuration for parallel connection of said electrical load to said second electrical source.

8. An apparatus as claimed in claim 1 wherein said electrical load has a connection point that can connect to said termination in both of said first configuration and said second configuration.

9. An apparatus as claimed in claim 1 wherein said series or parallel connection of said electrical load is achieved through series or parallel connection of said electrical load to said first electrical source and said second electrical source respectively via connection of said termination and said connection.

10. An apparatus as claimed in claim 1 wherein said termination consists of a socket.

11. An apparatus as claimed in claim 1 wherein said connection point is a plug.

12. An apparatus as claimed in claim 1 wherein said termination is at an end of a flexible electrical lead, distal from said power source.

13. An apparatus as claimed in claim 1 wherein said connection point is at a periphery of said electrical load.

14. An apparatus as claimed in claim 1 wherein said electrical connection has electrical contacts arranged therein to connect said load in parallel or series dependent on whether said first termination or said second termination is connected thereto.

15. An apparatus as claimed in claim 1 wherein said first voltage is higher than said second voltage.

16. An apparatus as claimed in claim 1 wherein said first voltage is 240 volts alternating current.

17. An apparatus as claimed in claim 1 wherein said second voltage is 110 volts alternating current.

18. An apparatus as claimed in claim 8 wherein said connection point is mounted on said electrical load, said container or part thereof, or remote from the electrical load at the end of an electrical lead.

19. A heating element adapted to heat an intermediate bulk container, comprising:
an electrical load that can connect via an electrical connection separately to both of either a first electrical source at a first voltage, and a second electrical source at a second voltage,
wherein said first electrical source via said electrical connection is applied to said load in series, and said second electrical source via said electrical connection is applied to said to load in parallel,
wherein said electrical connection has a termination for connecting with said electrical load in series or parallel,
said electrical load when connected in series or parallel having substantially the same power output.

20. A heating element as claimed in claim 19 wherein the heating element is a length or resistive wire or heating cable with electrical connections at either end to enable series connection, and in addition a mid-point electrical connection to enable parallel connection.

21. (canceled)

22. (canceled)
